(19) United States
(12) Patent Application Publication
(10) Pub. No.: US 2021/0143869 A1
(43) Pub. Date: May 13, 2021

(54) SIGNALING FOR MULTI-TRANSMIT-RECEIVE POINT (MULTI-TRP) SCHEMES

(71) Applicant: QUALCOMM Incorporated, San Diego, CA (US)

(72) Inventors: Mostafa KHOSHNEVISAN, San Diego, CA (US); Xiaoxia ZHANG, San Diego, CA (US); Jing SUN, San Diego, CA (US); Peter GAAL, San Diego, CA (US); Tao LUO, San Diego, CA (US)

(21) Appl. No.: 16/949,330

(22) Filed: Oct. 26, 2020

Related U.S. Application Data
(60) Provisional application No. 62/932,312, filed on Nov. 7, 2019.

(51) Int. Cl. H04B 7/024; H04L 5/00; H04W 72/04; H04L 1/08

(52) U.S. Cl. CPC H04B 7/024; H04L 5/0023; H04L 1/08; H04W 72/0446; H04W 72/048; H04W 72/042

(57) ABSTRACT

Various aspects of the present disclosure generally relate to wireless communication. In some aspects, a user equipment (UE) may receive information indicating at least one of an antenna port selection or a time-domain resource allocation (TDRA) configuration for a communication; identify a multi-transmit-receive point (multi-TRP) scheme for the communication based at least in part on: at least one of the antenna port selection or the TDRA configuration, and a set of multi-TRP schemes enabled for the UE; and perform the communication in accordance with the multi-TRP scheme. Numerous other aspects are provided.

### CROSS-REFERENCE TO RELATED APPLICATION

This patent application claims priority to U.S. Provisional Patent Application No. 62/932,312, filed on Nov. 7, 2019, entitled “SIGNALING FOR MULTI-TRANSMIT-RECEIVE POINT (MULTI-TRP) SCHEMES,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for signaling for multi-transmit-receive point (multi-TRP) schemes.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving information indicating at least one of an antenna port selection or a time-domain resource allocation (TDRA) configuration for a communication; identifying a multi-transmit-receive point (multi-TRP) scheme for the communication based at least in part on: at least one of the antenna port selection or the TDRA configuration, and a set of multi-TRP schemes enabled for the UE; and performing the communication in accordance with the multi-TRP scheme.

In some aspects, a method of wireless communication, performed by a base station, may include determining a multi-TRP scheme for a communication with a UE based at least in part on: at least one of an antenna port selection or a TDRA configuration, and a set of multi-TRP schemes enabled for the UE; transmitting information indicating at least one of the antenna port selection or the TDRA configuration for the communication; and performing the communication in accordance with the multi-TRP scheme.

In some aspects, a UE for wireless communication may include memory and one or more processors operatively coupled to the memory. The memory and the one or more processors may be configured to receive information indicating at least one of an antenna port selection or a TDRA configuration for a communication; identify a multi-TRP scheme for the communication based at least in part on: at least one of the antenna port selection or the TDRA configuration, and a set of multi-TRP schemes enabled for the UE; and perform the communication in accordance with the multi-TRP scheme.

In some aspects, a base station for wireless communication may include memory and one or more processors operatively coupled to the memory. The memory and the one or more processors may be configured to determine a multi-TRP scheme for a communication with a UE based at least in part on: at least one of an antenna port selection or a TDRA configuration, and a set of multi-TRP schemes enabled for the UE; transmit information indicating at least one of the antenna port selection or the TDRA configuration for the communication; and perform the communication in accordance with the multi-TRP scheme.

In some aspects, a non-transitory computer-readable medium may store one or more instructions for wireless communication. The one or more instructions, when executed by one or more processors of a UE, may cause the one or more processors to: receive information indicating at least one of an antenna port selection or a TDRA configuration for a communication; identify a multi-TRP scheme for the communication based at least in part on: at least one of the antenna port selection or the TDRA configuration, and a set of multi-TRP schemes enabled for the UE; and perform the communication in accordance with the multi-TRP scheme.

In some aspects, a non-transitory computer-readable medium may store one or more instructions for wireless communication. The one or more instructions, when executed by one or more processors of a base station, may cause the one or more processors to: determine a multi-TRP scheme for a communication with a UE based at least in part on: at least one of an antenna port selection or a TDRA configuration, and a set of multi-TRP schemes enabled for the UE; transmit information indicating at least one of the antenna port selection or the TDRA configuration for the communication; and perform the communication in accordance with the multi-TRP scheme.

In some aspects, an apparatus for wireless communication may include means for receiving information indicating at least one of an antenna port selection or a TDRA configuration for a communication; means for identifying a multi-TRP scheme for the communication based at least in part on: at least one of the antenna port selection or the TDRA configuration, and a set of multi-TRP schemes enabled for the apparatus; and means for performing the communication in accordance with the multi-TRP scheme.

In some aspects, an apparatus for wireless communication may include means for determining a multi-TRP scheme for a communication with a UE based at least in part on: at least one of an antenna port selection or a TDRA configuration, and a set of multi-TRP schemes enabled for the UE; means for transmitting information indicating at least one of the antenna port selection or the TDRA configuration for the communication; and means for performing the communication in accordance with the multi-TRP scheme.

Aspects generally include a method, apparatus, system, computer program product, non-transitory computer-readable medium, user equipment, base station, wireless communication device, and/or processing system as substantially described herein with reference to and as illustrated by the accompanying drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram conceptually illustrating an example of a wireless communication network, in accordance with various aspects of the present disclosure.

FIG. 2 is a block diagram conceptually illustrating an example of a base station in communication with a UE in a wireless communication network, in accordance with various aspects of the present disclosure.

FIG. 3 is a diagram illustrating an example of multi-TRP communication using a single control channel, in accordance with various aspects of the present disclosure.

FIG. 4 is a diagram illustrating an example of multi-TRP communication schemes, in accordance with various aspects of the present disclosure.

FIG. 5 is a diagram illustrating an example of indication of multi-TRP schemes and/or parameters for multi-TCI state communication, in accordance with various aspects of the present disclosure.

FIG. 6 is a diagram illustrating an example of indication of multi-TRP schemes and/or parameters for multi-TCI state communication, in accordance with various aspects of the present disclosure.

FIG. 7 is a diagram illustrating an example process performed, for example, by a user equipment, in accordance with various aspects of the present disclosure.

FIG. 8 is a diagram illustrating an example process performed, for example, by a base station, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. ABS is an entity that communicates with user equipment (UEs) and may also be referred to as a base station, a NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular radio access technology (RAT) and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

Controller/processor 240 of base station 110, controller/processor 280 of UE 120, and/or any other component(s) of FIG. 2 may perform one or more techniques associated with signaling for multi-TRP schemes, as described in more detail elsewhere herein. For example, controller/processor 240 of base station 110, controller/processor 280 of UE 120, and/or any other component(s) of FIG. 2 may perform or direct operations of, for example, process 700 of FIG. 7, process 800 of FIG. 8, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 700 of FIG. 7, process 800 of FIG. 8, and/or other processes as described herein. A scheduler 246 may schedule UEs for data transmission on the downlink and/or uplink.

In some aspects, UE 120 may include receiving information indicating at least one of an antenna port selection or a time-domain resource allocation (TDRA) configuration for a communication; means for identifying a multi-transmit-receive point (multi-TRP) scheme for the communication based at least in part on: at least one of the antenna port selection or the TDRA configuration, and a set of multi-TRP schemes enabled for the UE; means for performing the communication in accordance with the multi-TRP scheme; means for signaling a capability for the set of multi-TRP schemes; means for receiving configuration information indicating the set of multi-TRP schemes enabled for the UE; means for determining, based at least in part on the antenna port selection, a mapping of one or more redundancy versions for one or more respective TCI states of the communication; means for identifying the multi-TRP scheme as a repetition-based multi-TRP scheme based at least in part on the TDRA configuration including a value that indicates a number of repetitions; means for receiving information indicating that a single TCI state is to be used for the communication; means for using the single TCI state for a plurality of repetitions of the communication, wherein a number of the plurality of repetitions is determined based at least in part on the TDRA configuration; means for receiving information indicating that a plurality of TCI states are to be used for the communication, wherein the TDRA configuration indicates a single repetition of the communication; means for receiving information indicating that a plurality of TCI states are to be used for the communication, wherein the TDRA configuration indicates a single repetition of the communication; means for performing the single repetition of the communication in accordance with a single TCI state of the plurality of TCI states; means for receiving an indication of which TCI state, of the plurality of TCI states, is the single TCI state; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for determining a multi-TRP scheme for a communication with a UE based at least in part on: at least one of an antenna port selection or a TDRA configuration, and a set of multi-TRP schemes enabled for the UE; means for transmitting information indicating at least one of the antenna port selection or the TDRA configuration for the communication; means for performing the communication in accordance with the multi-TRP scheme; means for receiving a capability for the set of multi-TRP schemes; means for transmitting configuration information indicating the set of multi-TRP schemes enabled for the UE; means for transmitting information indicating that a plurality of TCI states are to be used for the communication, wherein the TDRA configuration indicates a single repetition of the communication; means for performing the single repetition of the communication in accordance with a single TCI state of the plurality of TCI states; means for transmitting an indication of which TCI state, of the plurality of TCI states, is the single TCI state; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

In a wireless network, a UE may be communicatively connected to a plurality of TRPs, referred to a multi-TRP configuration, and may transmit communications to, and/or receive communications from, the plurality of TRPs. Additionally, or alternatively, the UE may communicate with multiple antenna panels of a TRP in the multi-TRP configuration. Thus, the multiple TRPs or multiple antenna panels of a TRP are referred to herein as transmitters.

Multiple transmitters may transmit the same data (e.g., the same shared channel, such as the same physical downlink shared channel (PDSCH) and/or the like) to a UE. This type of transmission is referred to herein as a multi-TCI state transmission or a multi-TCI state communication, since each transmission may be associated with a respective TCI state. In such a case, a single downlink control information (DCI) communication, such as a single control channel, may be used to schedule the data from the multiple transmitters. In such a case, the single DCI may convey control information for each of the multiple transmitters. For example, the control information may include one or more fields that specify one or more (or multi-panel) parameters for the multi-TRP configuration, such as a TCI field that indicates one or more TCI states (which may indicate one or more quasi-colocation (QCL) relationships associated with the plurality of TRPs), an antenna port or demodulation reference signal (DMRS) port field (which may indicate one or more DMRS ports associated with the plurality of TRPs), a time domain resource allocation (TDRA) field, and/or the like. Dynamic switching between multi-TCI state and single-TCI state transmission may be supported based at least in part on how many TCI states are indicated by the TCI field. For example, a TCI field pointing to one TCI state may indicate a single-TCI state transmission, and a TCI field pointing to two or more TCI states may indicate a multi-TCI state transmission.

A transmission, such as a multi-TCI state transmission or a transmission associated with a single TCI state, may be performed in accordance with a multi-TRP scheme. A multi-TRP scheme may define how different layers of the multi-TCI state transmission are multiplexed and/or transmitted. Examples of multi-TRP schemes include spatial division multiplexing (SDM) schemes, frequency division multiplexing (FDM) schemes, time division multiplexing (TDM) schemes, and schemes involving repetitions. A set of multi-TRP schemes, of a plurality of multi-TRP schemes, may be enabled for the UE, such as by using radio resource control (RRC) signaling. The UE may use a multi-TRP scheme from the set of multi-TRP schemes enabled for the UE.

Signaling a selected multi-TRP scheme for the UE and/or parameters for performing a transmission using the multi-TRP scheme may involve significant overhead and latency. For example, using a dedicated signal or field to indicate the selected multi-TRP scheme may involve the addition of a new field in DCI, thereby increasing overhead and consuming computing resources. Furthermore, different multi-TRP schemes may involve different parameters and different constraints, which may be signaled to the UE, thus causing increased overhead and computing resource consumption, particularly if the selected multi-TRP scheme is signaled using a dedicated signal or field.

Some techniques and apparatuses described herein provide signaling of a selected multi-TRP scheme for a communication, an antenna port for the communication, and/or one or more other parameters for the multi-TRP scheme based at least in part on an antenna port selection or a TDRA configuration. For example, some techniques and apparatuses described herein provide indication of which multi-TRP scheme, of a set of multi-TRP schemes, is to be used based at least in part on the antenna port selection. Some techniques and apparatuses described herein may also provide indication of parameters for multi-TRP schemes, such as a mapping of TCI states, a mapping of redundancy value (RV) pairs, and/or the like. Furthermore, some techniques and apparatuses described herein provide indication of a repetition configuration for a multi-TRP scheme based at least in part on a TDRA configuration.

In this way, overhead may be reduced and computing resource consumption may be reduced, relative to separate signaling of the selected multi-TRP scheme and the antenna port selection, by combining the signaling of the selected multi-TRP scheme with signaling of the antenna port selection for the communication. Furthermore, parameters for communication using the selected multi-TRP scheme may be indicated based at least in part on the antenna port selection or the TDRA field, thereby reducing overhead and computing resource consumption relative to separate signaling of such parameters.

FIG. 3 is a diagram illustrating an example 300 of multi-TRP communication using a single control channel, in accordance with various aspects of the present disclosure. As shown, example 300 includes a UE 120, a TRP A 305 (referred to hereinafter as TRP A), and a TRP B 310 (referred to hereinafter as TRP B). TRP A and TRP B may be referred to herein as transmitters. It should be noted that the operations described with respect to example 300 can be performed by multiple antenna panels of a single TRP, or by a single antenna panel of a single TRP.

As shown by reference number 315, TRP A may provide a physical downlink control channel (PDCCH). For example, the PDCCH may include DCI that identifies resources for a shared channel to be transmitted by TRP A and TRP B. In some aspects, the DCI may include a TCI field that indicates one or more TCI states. When the TCI field indicates a single TCI state, TRP A or TRP B may perform single-TRP transmission using a single TCI state. When the TCI field indicates two or more TCI states, TRP A and/or TRP B may perform transmission using multiple TCI states (e.g., from a single TRP or from both of TRP A and TRP B).

The shared channel is shown by reference numbers 320 and 325. In some aspects, the shared channel shown by reference number 320 may be transmitted using a different TCI state than the shared channel shown by reference number 325. In some aspects, the shared channel shown by reference number 320 may be transmitted using a same TCI state as the shared channel shown by reference number 325. In some aspects, the shared channel shown by reference number 320 may be the same as the shared channel shown by reference number 325. In some aspects, the shared channel may be split between TRP A and TRP B, or TRP A and TRP B may transmit different versions of the shared channel.

As indicated above, FIG. 3 is provided as an example. Other examples may differ from what is described with respect to FIG. 3.

FIG. 4 is a diagram illustrating an example 400 of multi-TRP communication schemes, in accordance with various aspects of the present disclosure. Example 400 shows a spatial division multiplexing (SDM) scheme 410, a frequency division multiplexing (FDM) scheme 420, and a time division multiplexing (TDM) scheme 430. As shown, the vertical axis represents frequency (e.g., resource blocks (RBs)) and the horizontal axis represents time (e.g., symbols such as OFDM symbols). A time/frequency resource associated with a first QCL state, corresponding to a first TCI state associated with TRP 1 (e.g., the first group), is indicated by a white fill, and a time/frequency resource associated with a second QCL state, corresponding to a second TCI state associated with TRP 2 (e.g., the second group) is shown by a diagonal fill. Symbols containing a DMRS are shown by ovals.

The SDM scheme 410 may be referred to as scheme 1a in some contexts. In the SDM scheme 410, different TRPs may transmit different spatial layers in overlapping time/frequency resources (e.g., overlapping RBs/symbols). In such a case, the different spatial layers may be transmitted with different TCI states since the different spatial layers are transmitted by different TRPs. In some aspects, DMRS ports corresponding to different TCI states may be in different code division multiplexing (CDM) groups. As just one example, two layers (e.g., DMRS ports 0 and 1 in a first CDM group) may be transmitted with a first TCI state, and two layers (e.g., DMRS ports 2 and 3 in a second CDM group) may be transmitted with a second TCI state.

The FDM scheme 420 may be referred to as scheme 2 in some contexts. In the FDM scheme 420, different sets of RBs are transmitted by the different TRPs using different TCI states. For example, in a first FDM scheme, referred to as scheme 2a, one codeword may be transmitted in both sets of RBs. In a second FDM scheme, referred to as scheme 2b, two codewords of the same transport block may be transmitted (e.g., with a same redundancy version (RV) value or with different RV values).

The TDM scheme 430 may include two schemes, which may be referred to as scheme 3 and scheme 4. In the TDM scheme 430 generally, different sets of symbols (e.g., different mini-slots or slots) may be transmitted with different TCI states, and repetitions of the communication may be performed. In scheme 3, repetitions may be performed within a slot. In scheme 4, repetitions may be performed across slots. For scheme 4, a number of repetitions (e.g., a number of transmission occasions) may be dynamically indicated by a TDRA field in DCI, such as the PDCCH 315 of FIG. 3. The TDRA field in the DCI may point to a row of a time domain allocation list, wherein the row indicates a mapping type, a KO value, and a starting symbol and length. For scheme 4, a number of repetitions may be indicated by the time domain allocation list.

In scheme 4, in some aspects, a same mapping type, same starting symbol, and same length may be applied to all transmission occasions. When a TCI field in the DCI indicates two TCI states, the mapping between transmission occasions and TCI states may be configured using a cyclical mapping (e.g., TCI states #1, #2, #1, #2 are mapped to 4 transmission occasions) or a sequential mapping (e.g., TCI states #1, #1, #2, #2 are mapped to 4 transmission occasions). In some configurations, a maximum of two layers may be used. In the case of two layers being used, the two DMRS ports of the two layers may belong to the same DMRS CDM group. Thus, a limited number of DMRS port entries may be needed.

As indicated above, FIG. 4 is provided as an example. Other examples may differ from what is described with respect to FIG. 4.

FIG. 5 is a diagram illustrating an example 500 of indication of multi-TRP schemes and/or parameters for communication, in accordance with various aspects of the present disclosure. As shown, example 500 includes a UE 120, a first transmitter 505 (e.g., TRP 305/310 or an antenna panel of TRP 305/310), and a second transmitter 510 (e.g., TRP 305/310 or an antenna panel of TRP 305/310). In some aspects, the first transmitter 505 and the second transmitter 510 may be different antenna panels of a single TRP. In some aspects, the first transmitter 505 and the second transmitter 510 may be different TRPs.

As shown in FIG. 5, and by reference number 515, the first transmitter 505 may provide configuration information to the UE 120. The configuration information may indicate a set of multi-TRP schemes to be enabled for the UE 120. For example, the set of multi-TRP schemes may be selected from schemes 1a, 1b, 2a, 2b, 3, 4, or other multi-TRP schemes not explicitly described herein. In some aspects, the UE 120 may provide information indicating one or more multi-TRP schemes that the UE 120 is capable of using or that the UE 120 prefers to use. In this case, the first transmitter 505 may select the set of multi-TRP schemes from the one or more multi-TRP schemes, or may select the set of multi-TRP schemes based at least in part on the one or more multi-TRP schemes. In some aspects, the configuration information may include an RRC message, an RRC parameter, and/or the like. In some aspects, the configuration information may indicate a TDRA configuration, such as a TDRA table and/or the like, which is described in more detail in connection with FIG. 6.

As shown by reference number 520, the first transmitter 505 may provide DCI to the UE 120. For example, the first transmitter 505 may provide the DCI using a PDCCH and/or the like. The DCI may include information indicating an antenna port selection and/or one or more parameters for a communication to be performed by the UE 120. In some aspects, the DCI may include a TDRA field indicating a TDRA value of a TDRA configuration, as described in more detail in connection with FIG. 6. In some aspects, a size of an antenna port field of the DCI may be based at least in part on the set of multi-TRP schemes (e.g., a larger antenna port field may be used when more multi-TRP schemes are enabled). In some aspects, a size of the antenna port field of the DCI may be independent from the set of multi-TRP schemes. The communication may be associated with a single TCI state or multiple TCI states. A communication associated with multiple TCI states may be referred to as a multi-TCI state communication.

As shown by reference number 525, the UE 120 may determine a DMRS port table corresponding to the set of multi-TRP schemes. For example, different sets of multi-TRP schemes may be associated with different DMRS port tables. A DMRS port table may indicate a number of DMRS CDM groups without data, a set of DMRS ports, and a corresponding multi-TRP scheme. In some aspects, the DMRS port table may indicate other information, such as an RV value mapping, a repetition mapping, and/or the like.

As one example, when schemes 1a, 2a, 2b, and 3 are enabled, the UE 120 may use a DMRS port table similar to Table 1, below, to determine the multi-TRP scheme.

TABLE 1

| | Number of DMRS | | |
|---|---|---|---|
| Antenna | CDM group(s) | DMRS | Multi-TRP |
| Port Value | without data | port(s) | scheme |
| 0 | 2 | 0; 2 | SDM |
| 1 | 2 | 0, 1; 2 | (scheme 1a) |
| 2 | 2 | 0; 2, 3 | |
| 3 | 2 | 0, 1; 2, 3 | |
| 4 | 1 | 0 | FDM |
| 5 | 1 | 0, 1 | (scheme 2a) |
| 6 | 2 | 0 | |
| 7 | 2 | 0, 1 | |
| 8 | 1 | 0 | FDM |
| 9 | 1 | 0, 1 | (scheme 2b) |
| 10 | 2 | 0 | |
| 11 | 2 | 0, 1 | |
| 12 | 1 | 0 | TDM |
| 13 | 1 | 0, 1 | (scheme 3) |
| 14 | 2 | 0 | |
| 15 | 2 | 0, 1 | |

In the “DMRS port(s)” column, a semicolon separates DMRS ports associated with different DMRS groups. For example, for antenna port value 0, DMRS port 0 may be associated with a first DMRS CDM group, and DMRS port 2 may be associated with a second DMRS CDM group. For antenna port value 1, DMRS ports 0 and 1 may be associated with a first DMRS CDM group and DMRS port 2 may be associated with a second DMRS CDM group. In this way, an antenna port value, such as the one indicated in the DCI, may be used to indicate which multi-TRP scheme is to be used as well as other information for the selected multi-TRP scheme, such as a number of DMRS CD

M groups and a DMRS port configuration. This may reduce overhead and thus conserve computing resources in comparison to explicitly signaling the selected multi-TRP scheme separately from the antenna port configuration.

As another example, when schemes 1a, 2a, and 3 are enabled, the UE 120 may use a DMRS port table similar to Table 2, below, to determine the multi-TRP scheme.

TABLE 2

| | Number of DMRS | | |
|---|---|---|---|
| Antenna | CDM group(s) | DMRS | Multi-TRP |
| Port Value | without data | port(s) | scheme |
| 0 | 2 | 0; 2 | SDM (scheme 1a) |
| 1 | 2 | 0, 1; 2 | |
| 2 | 2 | 0; 2, 3 | |
| 3 | 2 | 0, 1; 2, 3 | |
| 4 | 1 | 0 | FDM (scheme 2a) |
| 5 | 1 | 0, 1 | |
| 6 | 2 | 0 | |
| 7 | 2 | 0, 1 | |
| 8 | 1 | 0 | TDM (scheme 3): TCI2 |
| 9 | 1 | 0, 1 | is mapped to the first |
| 10 | 2 | 0 | repetition while TCI1 is |
| 11 | 2 | 0, 1 | mapped to the second |
| | | | repetition |
| 12 | 1 | 0 | TDM (scheme 3) |
| 13 | 1 | 0, 1 | |
| 14 | 2 | 0 | |
| 15 | 2 | 0, 1 | |

Table 2, and more specifically the multi-TRP scheme indicated by antenna port values 8, 9, 10, and 11, indicates a mapping of TCI states for a repetitious transmission. For example, Table 2 may be used when a TCI field of the DCI indicates multiple TCI states.

As another example, when schemes 1a, 2a, and 2b are enabled, the UE 120 may use a DMRS port table similar to Table 3, below, to determine the multi-TRP scheme.

TABLE 3

| | Number of DMRS | | |
|---|---|---|---|
| Antenna | CDM group(s) | DMRS | Multi-TRP |
| Port Value | without data | port(s) | scheme |
| 0 | 2 | 0; 2 | SDM (scheme 1a) |
| 1 | 2 | 0, 1; 2 | |
| 2 | 2 | 0; 2, 3 | |
| 3 | 2 | 0, 1; 2, 3 | |
| 4 | 1 | 0 | FDM (scheme 2a) |
| 5 | 1 | 0, 1 | |
| 6 | 2 | 0 | |
| 7 | 2 | 0, 1 | |
| 8 | 1 | 0 | FDM (scheme 2b) |
| 9 | 1 | 0, 1 | |
| 10 | 2 | 0 | |
| 11 | 2 | 0, 1 | |
| 12 | 1 | 0 | FDM (scheme 2b): First |
| 13 | 1 | 0, 1 | value of RV pair is |
| 14 | 2 | 0 | applied to TCI state 2 |
| 15 | 2 | 0, 1 | while second value of RV |
| | | | pair is applied to TCI |
| | | | state 1 |

Table 3, and more specifically the multi-TRP scheme indicated by antenna port values 12, 13, 14, and 15, indicates a mapping of RV value pairs (as indicated by an RV field of the DCI) to TCI states (as indicated by a TCI field of the DCI) for a repetitious transmission. For example, Table 2 may be used when a TCI field of the DCI indicates multiple TCI states.

As shown by reference number 530, the UE 120 may determine a selected multi-TRP scheme, from the set of multi-TRP schemes, based at least in part on the antenna port selection indicated by the DCI. For example, the UE 120 may determine the selected multi-TRP scheme using the DMRS port table corresponding to the set of multi-TRP schemes. The UE 120 may identify a row of the table corresponding to the antenna port selection indicated in the DCI, and may identify a multi-TRP scheme according to the row of the table. As an example, the UE 120 may be configured with schemes 1, 2a, and 2b, and the DCI may indicate an antenna port selection of 7. In this case, the UE 120 may identify FDM scheme 2a by reference to a DMRS port table similar to Table 2.

As shown by reference number 535, the UE 120 may interpret (e.g., process) the one or more parameters according to the DMRS port table. For example, the one or more parameters may include a TCI value, an RV value, and/or the like. If the one or more parameters include a TCI value that indicates multiple TCI states, the UE 120 may determine a mapping of the TCI states using a DMRS port table similar to Table 2. If the one or more parameters include a TCI value that indicates multiple TCI states and an RV value that indicates an RV pair, the UE 120 may determine a mapping of the RV pair and the multiple TCI states using a DMRS port table similar to Table 3. In this way, the UE 120 may determine a configuration for the multi-TRP state based at least in part on the antenna port selection, thereby reducing overhead and conserving computing resources that would otherwise be used to explicitly signal the configuration for the multi-TRP state.

As shown by reference numbers 540 and 545, the UE 120 may receive a communication in accordance with the selected multi-TRP scheme and/or the one or more parameters. For example, the UE 120 may perform the communication in accordance with the selected multi-TRP scheme using a mapping associated with the one or more parameters.

As indicated above, FIG. 5 is provided as an example. Other examples may differ from what is described with regard to FIG. 5.

FIG. 6 is a diagram illustrating an example 600 of indication of multi-TRP schemes and/or parameters for communication, in accordance with various aspects of the present disclosure. As shown, example 600 includes a UE 120, a first transmitter 505, and a second transmitter 510.

As shown in FIG. 6, and by reference number 605, the first transmitter 505 may provide configuration information to the UE 120. As further shown, the configuration information may identify a time-domain resource allocation (TDRA) list. The TDRA list may identify configurations for a TDM scheme of the UE 120, such as TDM scheme 4 described in connection with FIG. 4. For example, rows of the TDRA list may identify mapping types, K0 values, starting symbols, lengths, and/or a quantity of repetitions or transmission occasions for a multi-TCI state communication. In some aspects, the TDRA list may be associated with a PDSCH-TimeDomainResourceAllocation-r16 RRC parameter. In some aspects, the number of repetitions or transmission occasions may be indicated by the higher layer parameter repetitionNumber-r16 of PDSCH-TimeDomainResourceAllocation-r16.

As shown by reference number 610, the first transmitter 505 may provide DCI to the UE 120. As further shown, the DCI may indicate a TDRA value corresponding to a row of the TDRA list (e.g., via a “Time domain resource assignment” DCI field). In some aspects, as shown, the DCI may indicate a TCI value (e.g., via a “Transmission Configuration Information” DCI field). For example, a TCI field of the DCI may include a TCI value indicating a number of TCI states to be used for a communication.

As shown by reference number 615, the UE 120 may determine that a TDM scheme 4 (described elsewhere herein) is to be used for a multi-TCI state communication. For example, the UE 120 may determine that a repetition-based multi-TRP scheme (e.g., TDM scheme 4) is to be used. In some aspects, the UE 120 may determine that TDM scheme 4 is to be used for the communication based at least in part on the configuration information. For example, the UE 120 may determine that TDM scheme 4 is to be used based at least in part on the TDRA list including a row that indicates a number of repetitions to be used for the communication. Determining that TDM scheme 4 is to be used based at least in part on the TDRA list may be referred to as a semi-static determination. The semi-static determination may conserve signaling resources that would otherwise be used to dynamically signal that the UE 120 is to use TDM scheme 4.

As another example, the UE 120 may determine that TDM scheme 4 is to be used based at least in part on the TDRA value indicating a row of the TDRA list that is associated with a plurality of repetitions. Determining that TDM scheme 4 is to be used based at least in part on the TDRA value pointing to a row of the TDRA list associated with a plurality of repetitions may be referred to as a dynamic determination. For example, if the TDRA row indicates a value corresponding to more than one repetition, the UE 120 may determine scheme 4. The dynamic determination may allow for switching between TDM scheme 4 and other schemes using DCI, thereby improving flexibility of the UE 120's multi-TRP communication configuration.

As shown by reference number 620, in some aspects, the UE 120 may use an indicated TCI state for all repetitions of the communication. For example, if the TCI field of the DCI indicates a single TCI state, and if the UE 120 is to use TDM scheme 4 for the communication, then the UE 120 may use the single TCI state for all repetitions of the communication. In this case, the number of repetitions may be indicated by the TDRA value of the DCI.

As shown by reference number 625, in some aspects, the UE 120 may select a TCI state, from a plurality of TCI states, for a repetition. For example, if the TCI field of the DCI indicates two TCI states, the TDRA value indicates a single repetition, and the UE 120 is to use TDM scheme 4 for the communication, then the UE 120 may use a selected TCI state for the repetition. In some aspects, the selected TCI state may be a first TCI state. In some aspects, the selected TCI state may be indicated in the DCI (e.g., using an existing field or a dedicated field), or may be configured using RRC or a different configuration technique.

In some aspects, when the UE 120 performs the semi-static determination to use TDM scheme 4, a size of the TDRA field may be increased, and a size of the antenna port field may be decreased, relative to when the UE 120 does not perform the semi-static determination to use TDM scheme 4. This may provide increased flexibility for TDRA indication while reducing overhead associated with DMRS/antenna port indication. For example, the TDRA field may include 5 or 6 bits, thus enabling the TDRA field to indicate the number of repetitions. The antenna port field may have 2 or 3 bits, as a smaller number of DMRS port entries may be needed for TDM scheme 4. When the TDRA list includes a number of repetitions, then the antenna port field may indicate a row of a different DMRS port table that has a smaller number of entries, corresponding to the smaller size of the antenna port field.

As shown by reference numbers 630 and 635, the UE 120 may perform the communication. In example 600, the UE 120 may perform the communication in accordance with TDM scheme 4, and may configure repetitions of the multi-TCI state as described in connection with reference numbers 620 or 625.

As indicated above, FIG. 6 is provided as an example. Other examples may differ from what is described with regard to FIG. 6.

FIG. 7 is a diagram illustrating an example process 700 performed, for example, by a UE, in accordance with various aspects of the present disclosure. Example process 700 is an example where the UE (e.g., UE 120 and/or the like) performs operations associated with signaling for multi-TRP schemes.

As shown in FIG. 7, in some aspects, process 700 may include receiving information indicating at least one of an antenna port selection or a time-domain resource allocation (TDRA) configuration for a communication (block 710). For example, the UE (e.g., using antenna 252, DEMOD 254, MIMO detector 256, receive processor 258, controller/processor 280, and/or the like) may receive information indicating at least one of an antenna port selection or a TDRA configuration for a communication, as described above.

As further shown in FIG. 7, in some aspects, process 700 may include identifying a multi-transmit-receive point (multi-TRP) scheme for the communication based at least in part on: at least one of the antenna port selection or the TDRA configuration, and a set of multi-TRP schemes enabled for the UE (block 720). For example, the UE (e.g., using controller/processor 280 and/or the like) may identify a multi-TRP scheme for the communication based at least in part on at least one of the antenna port selection or the TDRA configuration, and a set of multi-TRP schemes enabled for the UE, as described above.

As further shown in FIG. 7, in some aspects, process 700 may include performing the communication in accordance with the multi-TRP scheme (block 730). For example, the UE (e.g., using antenna 252, DEMOD 254, MIMO detector 256, receive processor 258, controller/processor 280, and/or the like) may perform the communication in accordance with the multi-TRP scheme, as described above.

Process 700 may include additional aspects, such as any single aspect or any combination of aspects described below and/or in connection with one or more other processes described elsewhere herein.

In a first aspect, process 700 includes signaling a capability for the set of multi-TRP schemes; and receiving configuration information indicating the set of multi-TRP schemes enabled for the UE.

In a second aspect, alone or in combination with the first aspect, the antenna port selection is based at least in part on a demodulation reference (DMRS) port table corresponding to the set of multi-TRP schemes enabled for the UE.

In a third aspect, alone or in combination with one or more of the first and second aspects, a size of a field of the antenna port selection is based at least in part on the set of multi-TRP schemes enabled for the UE.

In a fourth aspect, alone or in combination with one or more of the first through third aspects, a size of a field of the antenna port selection is independent from the set of multi-TRP schemes enabled for the UE.

In a fifth aspect, alone or in combination with one or more of the first through fourth aspects, the antenna port selection indicates a mapping of a plurality of transmission configuration indicator (TCI) states for a plurality of repetitions of the communication.

In a sixth aspect, alone or in combination with one or more of the first through fifth aspects, a first value of the antenna port selection corresponds to a mapping of a first TCI state, of the plurality of TCI states, to a first repetition, of the plurality of repetitions, and a second TCI state, of the plurality of TCI states, to a second repetition of the plurality of repetitions, and wherein a second value of the antenna port selection corresponds to a mapping of the first TCI state to the second repetition and the second TCI state to the first repetition.

In a seventh aspect, alone or in combination with one or more of the first through sixth aspects, process 700 includes determining, based at least in part on the antenna port selection, a mapping of a plurality of redundancy versions (RVs) for a plurality of respective transmission configuration indicator (TCI) states of the communication.

In an eighth aspect, alone or in combination with one or more of the first through seventh aspects, a first value of the antenna port selection corresponds to a mapping of a first RV of the plurality of RVs, to a first TCI state, of the plurality of respective TCI states, and second RV, of the plurality of RVs, to a second TCI state of the plurality of respective TCI states, and wherein a second value of the antenna port selection corresponds to a mapping of the first RV to the second TCI state and the second RV to the first TCI state.

In a ninth aspect, alone or in combination with one or more of the first through eighth aspects, identifying the multi-TRP scheme for the communication further comprises identifying the multi-TRP scheme as a repetition-based multi-TRP scheme in different slots (e.g., scheme 4) based at least in part on the TDRA configuration including a value that indicates a number of repetitions.

In a tenth aspect, alone or in combination with one or more of the first through ninth aspects, when the TDRA configuration includes the value that indicates the number of repetitions and when the multi-TRP scheme is the repetition-based multi-TRP scheme in different slots, the TDRA configuration has an increased size and a field of the antenna port selection has a decreased size relative to when the multi-TRP scheme is not a repetition-based multi-TRP scheme in different slots or the TDRA configuration does not include the value that indicates the number of repetitions.

In an eleventh aspect, alone or in combination with one or more of the first through tenth aspects, identifying the multi-TRP scheme for the multi-TCI state communication further comprises identifying the multi-TRP scheme as a repetition-based multi-TRP scheme in different slots based at least in part on an indicated value of the TDRA configuration being associated with a plurality of repetitions.

In a twelfth aspect, alone or in combination with one or more of the first through eleventh aspects, the indicated value comprises a row of a TDRA table identified by the TDRA configuration, and wherein the indicated value is based at least in part on a TDRA field of downlink control information received by the UE.

In a thirteenth aspect, alone or in combination with one or more of the first through twelfth aspects, identifying the multi-TRP scheme for the communication as a repetition-based multi-TRP scheme in different slots is based at least in part on downlink control information indicating that the communication is associated with multiple transmission configuration indicator (TCI) states, and the process 700 further comprises receiving a number of repetitions of the communication indicated by the indicated value of the TDRA configuration, each repetition of the plurality of repetitions using a TCI state of the multiple TCI states

In a fourteenth aspect, alone or in combination with one or more of the first through thirteenth aspects, the multi-TRP scheme is a repetition-based multi-TRP scheme in different slots, and the method further comprises:

In a fifteenth aspect, alone or in combination with one or more of the first through fourteenth aspects, receiving information indicating that a single transmission configuration indicator (TCI) state is to be used for the communication; and using the single TCI state for a plurality of repetitions of the communication, wherein a number of the plurality of repetitions is determined based at least in part on the TDRA configuration and based at least in part on a TDRA field of downlink control information received by the UE.

In a sixteenth aspect, alone or in combination with one or more of the first through fifteenth aspects, process 700 includes receiving information indicating that a plurality of transmission configuration indicator (TCI) states are to be used for the communication, wherein the TDRA configuration indicates a single repetition of the communication; and performing the single repetition of the communication in accordance with a single TCI state of the plurality of TCI states.

In a seventeenth aspect, alone or in combination with one or more of the first through sixteenth aspects, the single TCI state is a first TCI state of the plurality of TCI states.

In an eighteenth aspect, alone or in combination with one or more of the first through seventeenth aspects, process 700 includes receiving an indication of which TCI state, of the plurality of TCI states, is the single TCI state.

In a nineteenth aspect, alone or in combination with one or more of the first through eighteenth aspects, the communication is a multi transmission configuration indicator (multi-TCI) state communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a base station, in accordance with various aspects of the present disclosure. Example process 800 is an example where the base station (e.g., BS 110, first transmitter 505, second transmitter 510, and/or the like) performs operations associated with signaling for multi-TRP schemes.

As shown in FIG. 8, in some aspects, process 800 may include determining a multi-TRP scheme for a communication with a UE based at least in part on at least one of an antenna port selection or a TDRA configuration, and a set of multi-TRP schemes enabled for the UE (block 810). For example, the base station (e.g., using controller/processor 240 and/or the like) may determine a multi-TRP scheme for a communication with a UE based at least in part on at least one of an antenna port selection or a TDRA configuration, and a set of multi-TRP schemes enabled for the UE, as described above.

As further shown in FIG. 8, in some aspects, process 800 may include transmitting information indicating at least one of the antenna port selection or the TDRA configuration for the communication (block 820). For example, the base station (e.g., using controller/processor 240, transmit processor 220, TX MIMO processor 230, MOD 232, antenna 234, and/or the like) may transmit information indicating at least one of the antenna port selection or the TDRA configuration for the communication, as described above.

As further shown in FIG. 8, in some aspects, process 800 may include performing the communication in accordance with the multi-TRP scheme (block 830). For example, the base station (e.g., using controller/processor 240, transmit processor 220, TX MIMO processor 230, MOD 232, antenna 234, and/or the like) may perform the communication in accordance with the multi-TRP scheme, as described above.

Process 800 may include additional aspects, such as any single aspect or any combination of aspects described below and/or in connection with one or more other processes described elsewhere herein.

In a first aspect, process 800 includes receiving a capability for the set of multi-TRP schemes; and transmitting configuration information indicating the set of multi-TRP schemes enabled for the UE.

In a second aspect, alone or in combination with the first aspect, the antenna port selection is based at least in part on a demodulation reference signal (DMRS) port table corresponding to the set of multi-TRP schemes enabled for the UE.

In a third aspect, alone or in combination with one or more of the first and second aspects, a size of a field of the antenna port selection is based at least in part on the set of multi-TRP schemes enabled for the UE.

In a fourth aspect, alone or in combination with one or more of the first through third aspects, a size of a field of the antenna port selection is independent from the set of multi-TRP schemes enabled for the UE.

In a fifth aspect, alone or in combination with one or more of the first through fourth aspects, the antenna port selection indicates a mapping of a plurality of transmission configuration indicator (TCI) states for a plurality of repetitions of the communication.

In a sixth aspect, alone or in combination with one or more of the first through fifth aspects, a first value of the antenna port selection corresponds to a mapping of a first TCI state, of the plurality of TCI states, to a first repetition, of the plurality of repetitions, and a second TCI state, of the plurality of TCI states, to a second repetition of the plurality of repetitions, and wherein a second value of the antenna port selection corresponds to a mapping of the first TCI state to the second repetition and the second TCI state to the first repetition.

In a seventh aspect, alone or in combination with one or more of the first through sixth aspects, the antenna port selection indicates a mapping of a plurality of redundancy versions (RVs) for a plurality of respective transmission configuration indicator (TCI) states of the communication.

In an eighth aspect, alone or in combination with one or more of the first through seventh aspects, a first value of the antenna port selection corresponds to a mapping of a first RV of the plurality of RVs, to a first TCI state, of the plurality of respective TCI states, and second RV, of the plurality of RVs, to a second TCI state of the plurality of respective TCI states, and wherein a second value of the antenna port selection corresponds to a mapping of the first RV to the second TCI state and the second RV to the first TCI state.

In a ninth aspect, alone or in combination with one or more of the first through eighth aspects, process 800 includes transmitting information indicating that a plurality of TCI states are to be used for the communication, wherein the TDRA configuration indicates a single repetition of the communication; and performing the single repetition of the communication in accordance with a single TCI state of the plurality of TCI states.

In a tenth aspect, alone or in combination with one or more of the first through ninth aspects, the single TCI state is a first TCI state of the plurality of TCI states.

In an eleventh aspect, alone or in combination with one or more of the first through tenth aspects, process 800 includes transmitting an indication of which TCI state, of the plurality of TCI states, is the single TCI state.

In a twelfth aspect, alone or in combination with one or more of the first through eleventh aspects, the communication is a multi transmission configuration indicator (multi-TCI) state communication.

In a thirteenth aspect, alone or in combination with one or more of the first through twelfth aspects, the TDRA configuration for the communication identifies the multi-TRP scheme for the communication as a repetition-based multi-TRP scheme in different slots based at least in part on the TDRA configuration including a value that indicates a number of repetitions.

In a fourteenth aspect, alone or in combination with one or more of the first through thirteenth aspects, when the TDRA configuration includes the value that indicates the number of repetitions and when the multi-TRP scheme is the repetition-based multi-TRP scheme in different slots, the TDRA configuration has an increased size and a field of an antenna port selection has a decreased size relative to when the multi-TRP scheme is not a repetition-based multi-TRP scheme in different slots or the TDRA configuration does not include the value that indicates the number of repetitions.

In a fifteenth aspect, alone or in combination with one or more of the first through fourteenth aspects, the TDRA configuration for the communication identifies the multi-TRP scheme for the communication as a repetition-based multi-TRP scheme in different slots based at least in part on an indicated value of the TDRA configuration being associated with a plurality of repetitions.

In a sixteenth aspect, alone or in combination with one or more of the first through fifteenth aspects, the indicated value comprises a row of a TDRA table identified by the TDRA configuration, and the indicated value is based at least in part on a TDRA field of downlink control information received by the UE.

In a seventeenth aspect, alone or in combination with one or more of the first through sixteenth aspects, the multi-TRP scheme is a repetition-based multi-TRP scheme in different slots, and the process 800 further comprises transmitting information indicating that a single TCI state is to be used for the communication; and using the single TCI state for a plurality of repetitions of the communication, wherein a number of the plurality of repetitions is determined based at least in part on the TDRA configuration and based at least in part on a TDRA field of downlink control information received by the UE.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication performed by a user equipment (UE), comprising:
receiving information indicating a time-domain resource allocation (TDRA) configuration for a communication;
identifying a multi-transmit-receive point (multi-TRP) scheme for the communication based at least in part on the TDRA configuration and a set of multi-TRP schemes enabled for the UE; and
performing the communication in accordance with the multi-TRP scheme.

2. The method of claim 1, wherein the communication is a multi transmission configuration indicator (multi-TCI) state communication.

3. The method of claim 1, further comprising:
signaling a capability for the set of multi-TRP schemes; and
receiving configuration information indicating the set of multi-TRP schemes enabled for the UE.

4. The method of claim 1, wherein identifying the multi-TRP scheme for the communication further comprises:
identifying the multi-TRP scheme as a repetition-based multi-TRP scheme in different slots based at least in part on the TDRA configuration including a value that indicates a number of repetitions.

5. The method of claim 4, wherein, when the TDRA configuration includes the value that indicates the number of repetitions and when the multi-TRP scheme is the repetition-based multi-TRP scheme in different slots, the TDRA configuration has an increased size and a field of an antenna port selection has a decreased size relative to when the multi-TRP scheme is not a repetition-based multi-TRP scheme in different slots or the TDRA configuration does not include the value that indicates the number of repetitions.

6. The method of claim 1, wherein identifying the multi-TRP scheme for the communication further comprises:
identifying the multi-TRP scheme as a repetition-based multi-TRP scheme in different slots based at least in part on an indicated value of the TDRA configuration being associated with a plurality of repetitions.

7. The method of claim 6, wherein the indicated value comprises a row of a TDRA table identified by the TDRA configuration, and wherein the indicated value is based at least in part on a TDRA field of downlink control information received by the UE.

8. The method of claim 6, wherein identifying the multi-TRP scheme for the communication as a repetition-based multi-TRP scheme in different slots is based at least in part on downlink control information indicating that the communication is associated with multiple transmission configuration indicator (TCI) states, and wherein the method further comprises:
receiving a number of repetitions of the communication indicated by the indicated value of the TDRA configuration, each repetition of the plurality of repetitions using a TCI state of the multiple TCI states.

9. The method of claim 1, wherein the multi-TRP scheme is a repetition-based multi-TRP scheme in different slots, and wherein the method further comprises:
receiving information indicating that a single transmission configuration indicator (TCI) state is to be used for the communication; and
using the single TCI state for a plurality of repetitions of the communication, wherein a number of the plurality of repetitions is determined based at least in part on the TDRA configuration and based at least in part on a TDRA field of downlink control information received by the UE.

10. The method of claim 1, further comprising:
receiving information indicating that a plurality of transmission configuration indicator (TCI) states are to be used for the communication, wherein the TDRA configuration indicates a single repetition of the communication; and
performing the single repetition of the communication in accordance with a single TCI state of the plurality of TCI states.

11. The method of claim 10, wherein the single TCI state is a first TCI state of the plurality of TCI states.

12. The method of claim 10, further comprising:
receiving an indication of which TCI state, of the plurality of TCI states, is the single TCI state.

13. A method of wireless communication performed by a base station, comprising:
determining a multi-transmit-receive point (multi-TRP) scheme for communication with a user equipment (UE) based at least in part on a time-domain resource allocation (TDRA) configuration and a set of multi-TRP schemes enabled for the UE;
transmitting information indicating the TDRA configuration for the communication; and
performing the communication in accordance with the multi-TRP scheme.

14. The method of claim 13, further comprising:
receiving a capability for the set of multi-TRP schemes; and
transmitting configuration information indicating the set of multi-TRP schemes enabled for the UE.

15. The method of claim 13, wherein the TDRA configuration for the communication identifies the multi-TRP scheme for the communication as a repetition-based multi-TRP scheme in different slots based at least in part on the TDRA configuration including a value that indicates a number of repetitions.

16. The method of claim 15, wherein, when the TDRA configuration includes the value that indicates the number of repetitions and when the multi-TRP scheme is the repetition-based multi-TRP scheme in different slots, the TDRA configuration has an increased size and a field of an antenna port selection has a decreased size relative to when the multi-TRP scheme is not a repetition-based multi-TRP scheme in different slots or the TDRA configuration does not include the value that indicates the number of repetitions.

17. The method of claim 13, wherein the TDRA configuration for the communication identifies the multi-TRP scheme for the communication as a repetition-based multi-TRP scheme in different slots based at least in part on an indicated value of the TDRA configuration being associated with a plurality of repetitions.

18. The method of claim 17, wherein the indicated value comprises a row of a TDRA table identified by the TDRA configuration, and wherein the indicated value is based at least in part on a TDRA field of downlink control information received by the UE.

19. The method of claim 13, wherein the multi-TRP scheme is a repetition-based multi-TRP scheme in different slots, and wherein the method further comprises:
transmitting information indicating that a single transmission configuration indicator (TCI) state is to be used for the communication; and
using the single TCI state for a plurality of repetitions of the communication, wherein a number of the plurality of repetitions is determined based at least in part on the TDRA configuration and based at least in part on a TDRA field of downlink control information received by the UE.

20. The method of claim 13, further comprising:
transmitting information indicating that a plurality of transmission configuration indicator (TCI) states are to be used for the communication, wherein the TDRA configuration indicates a single repetition of the communication; and
performing the single repetition of the communication in accordance with a single TCI state of the plurality of TCI states.

21. The method of claim 20, wherein the single TCI state is a first TCI state of the plurality of TCI states.

22. The method of claim 20, further comprising:
transmitting an indication of which TCI state, of the plurality of TCI states, is the single TCI state.

23. The method of claim 13, wherein the communication is a multi transmission configuration indicator (multi-TCI) state communication.

24. A user equipment (UE) for wireless communication, comprising:
a memory; and
one or more processors operatively coupled to the memory, the memory and the one or more processors configured to:
receive information indicating at least one of an antenna port selection or a time-domain resource allocation (TDRA) configuration for a communication;
identify a multi-transmit-receive point (multi-TRP) scheme for the communication based at least in part on:
at least one of the antenna port selection or the TDRA configuration, and
a set of multi-TRP schemes enabled for the UE; and
perform the communication in accordance with the multi-TRP scheme.

25. The UE of claim 24, wherein the one or more processors, when identifying the multi-TRP scheme for the communication, are further configured to:
identify the multi-TRP scheme as a repetition-based multi-TRP scheme in different slots based at least in part on the TDRA configuration including a value that indicates a number of repetitions.

26. The UE of claim 25, wherein, when the TDRA configuration includes the value that indicates the number of repetitions and when the multi-TRP scheme is the repetition-based multi-TRP scheme in different slots, the TDRA configuration has an increased size and a field of an antenna port selection has a decreased size relative to when the multi-TRP scheme is not a repetition-based multi-TRP scheme in different slots or the TDRA configuration does not include the value that indicates the number of repetitions.

27. The UE of claim 24, wherein the one or more processors, when identifying the multi-TRP scheme for the communication, are further configured to:
identify the multi-TRP scheme as a repetition-based multi-TRP scheme in different slots based at least in part on an indicated value of the TDRA configuration being associated with a plurality of repetitions.

28. The UE of claim 27, wherein the indicated value comprises a row of a TDRA table identified by the TDRA configuration, and wherein the indicated value is based at least in part on a TDRA field of downlink control information received by the UE.

29. The UE of claim 24, wherein the multi-TRP scheme is a repetition-based multi-TRP scheme in different slots, and wherein the one or more processors are configured to:
receive information indicating that a single transmission configuration indicator (TCI) state is to be used for the communication; and
use the single TCI state for a plurality of repetitions of the communication, wherein a number of the plurality of repetitions is determined based at least in part on the TDRA configuration and based at least in part on a TDRA field of downlink control information received by the UE.

30. A base station for wireless communication, comprising:
a memory; and
one or more processors operatively coupled to the memory, the memory and the one or more processors configured to:
determine a multi-transmit-receive point (multi-TRP) scheme for a communication with a user equipment (UE) based at least in part on:
at least one of an antenna port selection or a time-domain resource allocation (TDRA) configuration, and
a set of multi-TRP schemes enabled for the UE;
transmit information indicating at least one of the antenna port selection or the TDRA configuration for the communication; and
perform the communication in accordance with the multi-TRP scheme.
